(19) United States
(12) Patent Application Publication
(10) Pub. No.: US 2026/0169409 A1
(43) Pub. Date: Jun. 18, 2026

(54) IMAGE FORMING APPARATUS

(71) Applicant: KYOCERA Document Solutions Inc., Osaka (JP)

(72) Inventors: Jun NAKAI, Osaka (JP); Kenshin MATSUUCHI, Osaka (JP)

(73) Assignee: KYOCERA Document Solutions Inc., Osaka (JP)

(21) Appl. No.: 19/413,556

(22) Filed: Dec. 9, 2025

(30) Foreign Application Priority Data
Dec. 13, 2024 (JP) 2024-218539

(51) Int. Cl. G03G 15/00; G03G 15/01; G03G 15/043; G06K 15/02; H04N 1/028; H04N 1/053

(52) U.S. Cl. CPC G03G 15/5041; G03G 15/011; G03G 15/0189; G03G 15/043; G03G 15/5058; G03G 15/55; G06K 15/027; H04N 1/02865; H04N 1/053; G03G 2215/0005; G03G 2215/00059

(57) ABSTRACT

A control unit determines a displacement of writing start positions based the density of a correction image, adjusts timings of light emission of light-emitting elements and thereby corrects the displacement of the writing start positions. When the control unit performs correction processing, the control unit performs at least one of first processing and second processing. The control unit performs the first processing by determining, based on the density of a first image, whether unevenness in image density occurs on a surface to be scanned. The control unit performs the second processing by determining, based on the density of a second image, whether a light amount abnormality occurs in any one of a plurality of light-emitting elements.

### INCORPORATION BY REFERENCE

This application is based upon and claims the benefit of priority from the corresponding Japanese Patent Application No. 2024-218539 (filed on December 13, 2024), the entire contents of which are incorporated herein by reference.

### BACKGROUND

The present disclosure relates to electrophotographic image forming apparatuses.

An electrophotographic image forming apparatus includes an optical scanning device. The optical scanning device forms an electrostatic latent image on a surface to be scanned by scanning the surface to be scanned with a light beam. The electrostatic latent image on the surface to be scanned is developed into a toner image, and the toner image is transferred to a sheet.

For example, a multi-beam optical scanning device is installed in an image forming apparatus. The multi-beam image forming apparatus scans a surface to be scanned with a plurality of light beams. In this way, it is possible to expose a plurality of lines in one scan to achieve faster printing.

### SUMMARY

An image forming apparatus according to an aspect of the present disclosure includes an image carrying member, an optical scanning device, a development device and a control unit. The image carrying member includes a surface to be scanned. The optical scanning device includes a plurality of light-emitting elements arranged in a line at regular intervals and at a predetermined angle relative to a main scanning direction, and scans the surface to be scanned with light beams emitted from the plurality of light-emitting elements to form an electrostatic latent image on the surface to be scanned. The development device develops the electrostatic latent image using a toner to form a toner image. The control unit performs correction processing to correct a displacement of writing start positions of the plurality of light-emitting elements in the main scanning direction relative to the surface to be scanned. The control unit performs the correction processing by causing the optical scanning device and the development device to form a correction image that is the toner image used in the correction processing, determining the displacement of the writing start positions based on the density of the correction image and adjusting timings of light emission of the plurality of light-emitting elements based on the displacement of the writing start positions determined to correct the displacement of the writing start positions. When the control unit performs the correction processing, the control unit performs at least one of first processing and second processing. The control unit performs the first processing by causing the optical scanning device and the development device to form a first image that is the toner image used in the first processing, and determining, based on the density of the first image, whether unevenness in image density occurs on the surface to be scanned. The control unit performs the second processing by causing the optical scanning device and the development device to form a second image that is the toner image used in the second processing, and determining, based on the density of the second image, whether a light amount abnormality occurs in any one of the plurality of light-emitting elements.

### BRIEF DESCRIPTION OF THE DRAWINGS

FIG. 1 is a schematic view of an image forming apparatus according to an embodiment;

FIG. 2 is a schematic view of an image formation unit which includes a photosensitive drum and a development device in the embodiment;

FIG. 3 is a schematic view of an optical scanning device in the embodiment;

FIG. 4 is a perspective view of a light source unit in the embodiment;

FIG. 5 is a diagram showing positions of light-emitting elements in the embodiment;

FIG. 6 is a diagram showing positions of correction pattern images formed in the image forming apparatus according to the embodiment;

FIG. 7 is a detailed view of the correction pattern images formed in the image forming apparatus according to the embodiment;

FIG. 8 is a diagram showing a relationship between the amount of displacement and a differential density determined in the image forming apparatus according to the embodiment;

FIG. 9 is a detailed view of the correction pattern images formed in the image forming apparatus according to the embodiment (when a displacement occurs);

FIG. 10 is a diagram showing a relationship between the amount of displacement and the differential density determined in the image forming apparatus according to the embodiment (including a density straight line when unevenness in image density occurs);

FIG. 11 is a diagram showing the positions of first images and second images formed in the image forming apparatus according to the embodiment;

FIG. 12 is a detailed view of the first images formed in the image forming apparatus according to the embodiment;

FIG. 13 is a diagram showing a relationship between the amount of displacement and the differential density determined in the image forming apparatus according to the embodiment (including a density straight line when a light amount abnormality occurs in the light-emitting element); and

FIG. 14 is a detailed view of the second images formed in the image forming apparatus according to the embodiment.

### DETAILED DESCRIPTION

An image forming apparatus according to an embodiment of the present disclosure will be described below using a tandem color laser printer as an example. The present disclosure is not limited to printers, and can be applied to multi-functional peripherals which have a copying function and the like. The present disclosure is not limited to color machines, and can be applied to monochrome machines.

### Configuration of Image Forming Apparatus

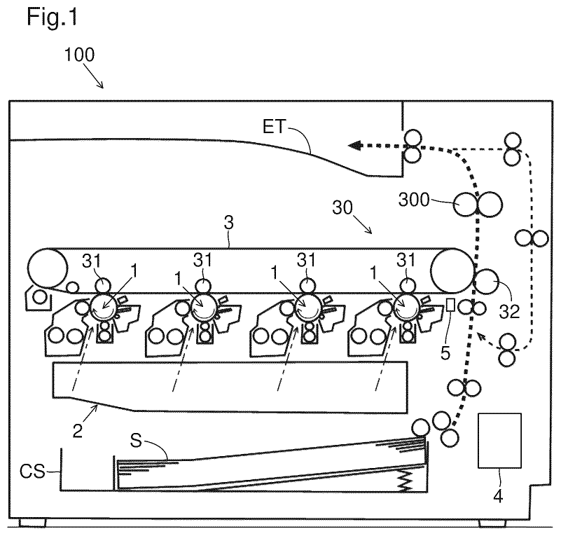

As shown in FIG. 1, the image forming apparatus 100 in the present embodiment includes a sheet conveyance path. In FIG. 1, the sheet conveyance path is schematically indicated by dashed lines with arrows. The image forming apparatus 100 supplies a sheet S stored in a cassette CS to the sheet conveyance path, and conveys the sheet S along the sheet conveyance path. Then, the image forming apparatus 100 prints an image on the sheet S being conveyed.

The image forming apparatus 100 includes four image formation units 1 which correspond to colors of cyan, magenta, yellow and black, respectively. The image forming apparatus 100 includes an optical scanning device 2.

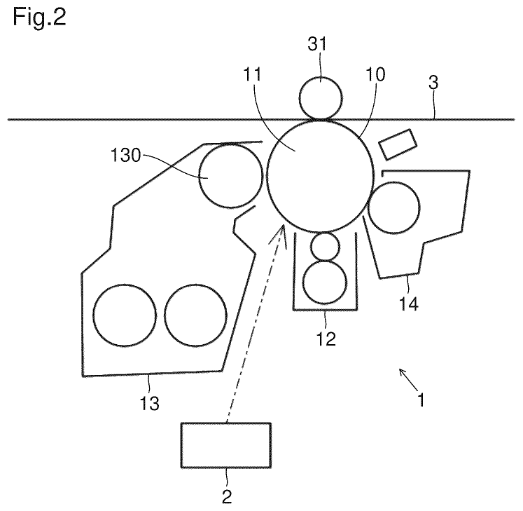

Each of the image formation units 1 has a configuration as shown in FIG. 2. Each of the image formation units 1 includes a photosensitive drum 11, a charging device 12, a development device 13 and a cleaning device 14. The photosensitive drum 11 corresponds to an “image carrying member”. The basic configurations of the image formation units 1 are the same as each other. Hence, in FIG. 2, for convenience, only one image formation unit 1 is shown.

The photosensitive drum 11 is rotatably supported. The photosensitive drum 11 includes its outer circumferential surface 10 as a surface to be scanned. In the following description, the outer circumferential surface 10 of the photosensitive drum 11 is simply referred to as the surface to be scanned 10. The charging device 12 charges the surface to be scanned 10.

The optical scanning device 2 scans and exposes the surface to be scanned 10 to form an electrostatic latent image on the surface to be scanned 10. The configuration of the optical scanning device 2 will be described in detail later.

The development device 13 includes a development roller 130. The development roller 130 is rotated while carrying a toner on its outer circumferential surface. The development device 13 supplies the toner on the development roller 130 to the surface to be scanned 10. In other words, the development device 13 supplies the toner to the electrostatic latent image. In this way, the electrostatic latent image is developed, and thus a toner image is formed on the surface to be scanned 10. The photosensitive drum 11 is rotated while carrying the toner image on the surface to be scanned 10. The cleaning device 14 cleans the surface to be scanned 10.

As shown in FIG. 1, the image forming apparatus 100 includes a transfer unit 30 which transfers the toner image to the sheet S. The transfer unit 30 transfers the toner image formed in each of the image formation units 1 to the sheet S. Although details will be described later, toner images of a correction image P, a first image A, a second image B and the like can also be transferred to the sheet S.

The transfer unit 30 includes an intermediate transfer belt 3. The intermediate transfer belt 3 is a seamless belt. The intermediate transfer belt 3 is rotatably supported. The intermediate transfer belt 3 are stretched on a plurality of tension rollers.

The transfer unit 30 includes four primary transfer rollers 31 corresponding to the colors of cyan, magenta, yellow and black. The primary transfer rollers 31 are disposed on the inner circumferential side of the intermediate transfer belt 3. Each of the primary transfer rollers 31 is pressed against, via the intermediate transfer belt 3, the photosensitive drum 11 (surface to be scanned 10) which carries the toner image of the corresponding color.

The transfer unit 30 includes a secondary transfer roller 32. The secondary transfer roller 32 is pressed against the outer circumferential surface of the intermediate transfer belt 3 to form a transfer nip between the intermediate transfer belt 3 and the secondary transfer roller 32. In the printing performed by the image forming apparatus 100, the sheet S is conveyed toward the transfer nip to pass through the transfer nip.

When a print request is input to the image forming apparatus 100, the image formation units 1 use the toners of the corresponding colors to form the toner images. In other words, the toner images are formed on the surfaces to be scanned 10. The primary transfer rollers 31 primarily transfer the toner images on the corresponding surfaces to be scanned 10 to the outer circumferential surface of the intermediate transfer belt 3. The intermediate transfer belt 3 is rotated while carrying the toner images on its outer circumferential surface. The secondary transfer roller 32 secondarily transfers the toner images from the outer circumferential surface of the intermediate transfer belt 3 to the sheet S while the sheet S is being passed through the transfer nip.

The image forming apparatus 100 includes a fixing roller pair 300. The fixing roller pair 300 includes a heating roller and a pressure roller. The heating roller incorporates a heater. The pressure roller is pressed against the heating roller to form a fixing nip between the heating roller and the pressure roller.

After the transfer of the toner images to the sheet S, the sheet S is passed through the fixing nip. Here, the sheet S is heated and pressurized. In this way, the toner images are fixed to the sheet S. Thereafter, the sheet S is ejected to an ejection tray ET.

The image forming apparatus 100 includes a control unit 4. The control unit 4 includes a CPU, an ASIC, a memory and the like. The control unit 4 controls printing performed by the image forming apparatus 100. The control unit 4 controls the feeding of the sheet S, the drive of various rotating members, exposure processing, development processing, primary transfer processing, secondary transfer processing, fixing processing and the like.

The image forming apparatus 100 also includes a density sensor 5. The density sensor 5 detects the density of the toner image on the outer circumferential surface of the intermediate transfer belt 3. The density sensor 5 is, for example, a reflective optical sensor. The density sensor 5 emits light toward the outer circumferential surface of the intermediate transfer belt 3, and receives light reflected off the outer circumferential surface of the intermediate transfer belt 3. When the toner image is present in the detection region of the density sensor 5, the light reflected off the toner image is received by the density sensor 5. The type of density sensor 5 is not particularly limited. For example, the toner image on the outer circumferential surface of the intermediate transfer belt 3 may be imaged, and based on the resulting image, the density of the toner image may be detected.

The density sensor 5 is connected to the control unit 4. The density sensor 5 outputs a value corresponding to the amount of light received to the control unit 4. The output value (that is, the amount of light received) of the density sensor 5 is changed according to the density of the toner image present in the detection region of the density sensor 5. The control unit 4 detects the density of the toner image on the outer circumferential surface of the intermediate transfer belt 3 based on the output of the density sensor 5.

### Configuration of Optical Scanning Device

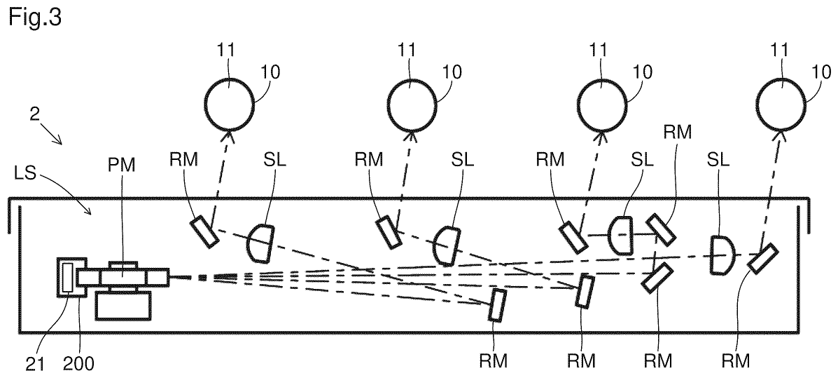

The optical scanning device 2 has a configuration as shown in FIG. 3. The optical scanning device 2 includes a laser scanning optical system LS. The laser scanning optical system LS deflects and scans light beams to form the electrostatic latent image on the surface to be scanned 10. The laser scanning optical system LS includes a polygon mirror PM, light reflecting mirrors RM, and lenses SL (for example, an fθ lens, a collimator lens and a cylindrical lens) and the like. In FIG. 3, the paths of the light beams are schematically indicated by alternate long and short dashed lines.

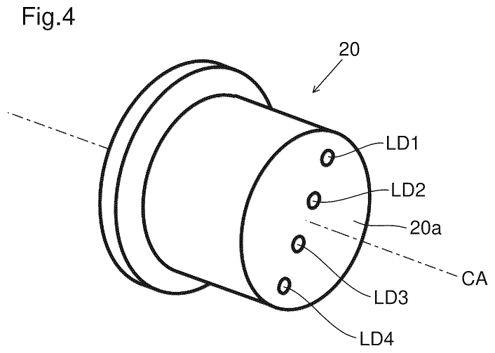

The optical scanning device 2 includes a light emission unit 200. The light emission unit 200 includes four light source units 20 (see FIG. 4). The four light source units 20 correspond to the colors of cyan, magenta, yellow and black, respectively.

Each of the light source units 20 has a configuration as shown in FIG. 4. The basic configurations of the light source units 20 are the same as each other. Hence, here, attention is focused on one light source unit 20, the configuration thereof will be described and the description of the other light source units 20 is omitted because the following description can be used for the other light source units 20.

The light source unit 20 includes a plurality of light-emitting elements LD. The light-emitting elements LD are laser diodes. Each of the light-emitting elements LD emits a light beam. In other words, the light source unit 20 emits a plurality of light beams. For example, the number of light-emitting elements LD is four. However, the present disclosure is not limited to this configuration. The number of light-emitting elements LD may be eight. When the number of light-emitting elements LD is four, the light source unit 20 emits four light beams.

The light source unit 20 is in the shape of a cylinder in which an axis CA extending in the direction of emission of the light beam serves as a center axis (cylindrical axis). In the following description, a direction orthogonal to the center axis CA is referred to as a radial direction.

The light source unit 20 includes a cylindrical holder (the symbol of which is omitted) with the center axis CA serving as a cylindrical axis, and emits the light beams from its tip end surface 20a. In other words, the light-emitting elements LD are arranged in the holder. The light-emitting elements LD are arranged in a line at regular intervals in the radial direction.

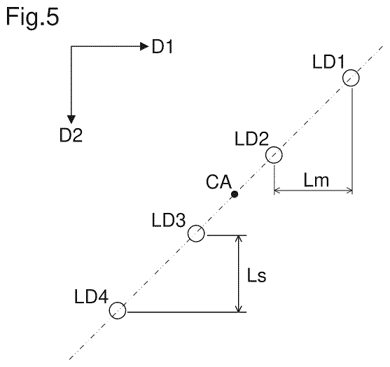

Here, in a state where the light source unit 20 is attached to the housing of the optical scanning device 2, as shown in FIG. 5, the light-emitting elements LD are arranged in a line at regular intervals and at a predetermined angle relative to a main scanning direction D1. In other words, the scanning positions of the light-emitting elements LD relative to the surface to be scanned 10 are arranged in a sub-scanning direction D2 orthogonal to the main scanning direction D1. In this way, it is possible to simultaneously scan a plurality of lines on the surface to be scanned 10.

In the configuration in which the light-emitting elements LD are arranged in a line at regular intervals and at a predetermined angle relative to the main scanning direction D1, the light source unit 20 is rotated around the center axis CA, and thus it is possible to adjust the beam pitch Ls, in the sub-scanning direction D2, of the light beams emitted from the light-emitting elements LD. The beam pitch Ls is determined based on the resolution of an image to be printed in the image forming apparatus 100. In FIG. 5, the light source unit 20 is rotated clockwise, and thus the beam pitch Ls is decreased. On the other hand, the light source unit 20 is rotated counterclockwise, and thus the beam pitch Ls is increased.

In the configuration described above, the positions of the light-emitting elements LD are displaced in the main scanning direction D1. Hence, when scanning performed by the light-emitting elements LD is started simultaneously, writing start positions (that is, scanning start positions) of the light beams emitted from the light-emitting elements LD in the main scanning direction D1 relative to the surface to be scanned 10 are displaced by a beam pitch Lm.

Hence, the control unit 4 appropriately controls timings of light emission of the light-emitting elements LD. In other words, the control unit 4 appropriately controls timings of start of writing performed with the light beams of the light-emitting elements LD on the surface to be scanned 10. The control unit 4 displaces the timings of start of writing performed by the light-emitting elements LD.

The light emission unit 200 includes a plurality of driver circuits 21 (see FIG. 3) corresponding to the light-emitting elements LD. Each of the driver circuits 21 is connected to the corresponding light-emitting element LD. Each of the driver circuits 21 supplies a current to the corresponding light-emitting element LD. In this way, each of the driver circuits 21 causes the corresponding light-emitting element LD to emit light.

The driver circuits 21 are connected to the control unit 4. The control unit 4 controls the driver circuits 21 such that the writing start positions of the light-emitting elements LD in the main scanning direction D1 relative to the surface to be scanned 10 are the same as each other.

Each of the driver circuits 21 can increase or decrease the current supplied to the corresponding light-emitting element LD. In other words, each of the driver circuits 21 can increase or decrease the amount of light emitted by the corresponding light-emitting element LD. The control unit 4 controls the driver circuits 21 to adjust the amounts of light emitted by the light-emitting elements LD.

In the following description, when it is necessary to distinguish between the light-emitting elements LD, serial numbers 1 to 4 are added to the ends of the reference numerals of the light-emitting elements LD in order from an upstream side to a downstream side in the sub-scanning direction D2.

### Correction Processing

In the manufacturing line of the optical scanning device 2, an optical sensor serving as a manufacturing jig is used to measure intervals between beam application positions of the light-emitting elements LD in the main scanning direction D1 relative to the surface to be scanned 10 (hereinafter simply referred to as the beam spot intervals). In this measurement, the jig (optical sensor) is installed in a position corresponding to the position of the surface to be scanned 10, and the light-emitting elements LD emit the light beams toward the jig. Measurement information (beam spot intervals) indicating the results of the measurement described above is previously stored in the memory of the control unit 4. The control unit 4 controls the timings of light emission of the light-emitting elements LD based on the measurement information.

For example, due to the influence of assembly tolerances and the like, the position of installation of the photosensitive drum 11 (the surface to be scanned 10) may be displaced from the ideal position. The position of installation of the optical scanning device 2 may be displaced from the ideal position. Hence, a difference between the beam spot intervals indicated by the measurement information and the actual beam spot intervals may be caused. In other words, in the control based on the measurement information, the writing start positions of the light-emitting elements LD in the main scanning direction D1 relative to the surface to be scanned 10 may be displaced. In this case, the image quality is lowered.

In order to suppress the occurrence of such an inconvenience, after the assembly of the image forming apparatus 100, the control unit 4 performs predetermined correction processing. The control unit 4 performs the correction processing to correct a displacement of the writing start positions of the light-emitting elements LD in the main scanning direction D1 relative to the surface to be scanned 10.

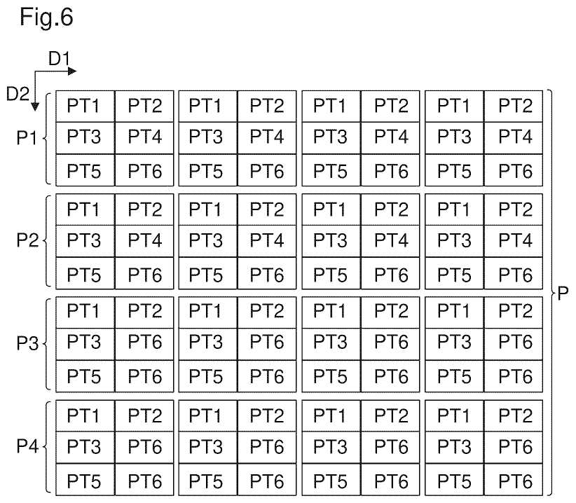

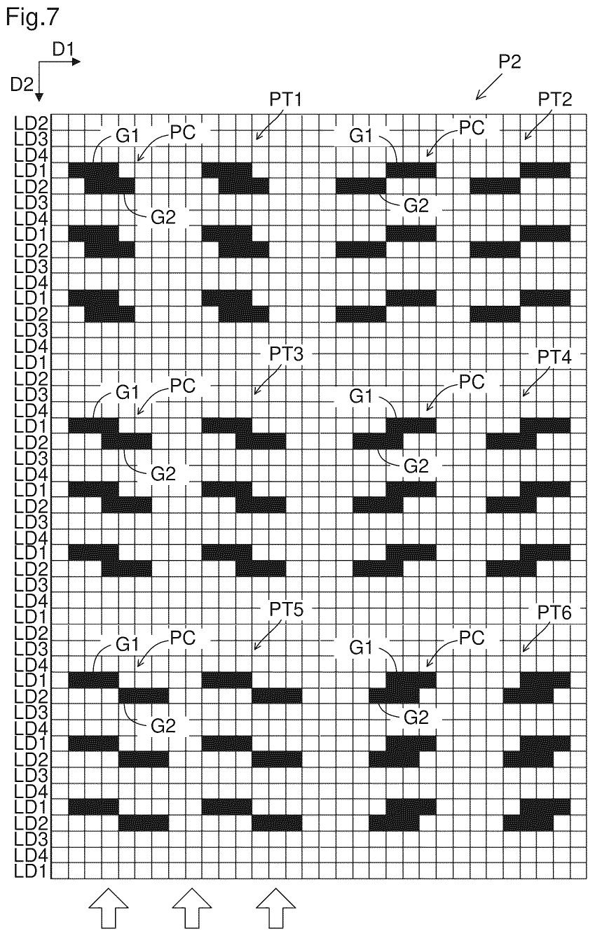

Specifically, as shown in FIGS. 6 and 7, the control unit 4 first causes the image formation unit 1 (including the development device 13) and the optical scanning device 2 to form a correction image P. The correction image P is a toner image which is used in the correction processing. For example, the image formation unit 1 corresponding to black is used in the formation of the correction image P. The optical scanning device 2 forms an electrostatic latent image of the correction image P on the surface to be scanned 10. The development device 13 develops the electrostatic latent image on the surface to be scanned 10 into the toner image to form the correction image P.

In the correction processing, the density of the correction image P is detected. Then, the correction processing is performed based on the density of the correction image P. Hence, the correction image P is transferred onto the outer circumferential surface of the intermediate transfer belt 3. Thereafter, for example, the density of the correction image P is detected with the density sensor 5. Although not shown in the figure, a density sensor capable of detecting the density of the toner image on the surface to be scanned 10 may be installed to detect the density of the correction image P on the surface to be scanned 10.

After the secondary transfer of the correction image P to the sheet S, the density of the correction image P transferred to the sheet S may be detected with a density sensor, and the detected density may be used in the correction processing. In this case, although not shown in the figure, a density sensor (for example, the same sensor as the density sensor 5) for detecting the correction image P secondarily transferred to the sheet S may be separately installed in the image forming apparatus 100. The position of detection performed by the density sensor is set to the downstream side of the sheet conveyance path in the sheet conveyance direction relative to the fixing nip.

Furthermore, after the secondary transfer of the correction image P to the sheet S, the sheet S to which the correction image P has been transferred may be able to be output from the image forming apparatus 100. Then, the correction image P transferred to the sheet S may be read, and based on image data of the correction image P obtained by the reading, the density of the correction image P may be detected. Based on the brightness value of the correction image P in the image data, the density of the correction image P can be detected.

The image forming apparatus 100 may be a multi-functional peripheral which includes an image reading device for generating image data by reading an image. In this case, the image reading device of the image forming apparatus 100 may be used to read the correction image P transferred to the sheet S, and based on image data of the correction image P obtained by the reading, the density of the correction image P may be detected.

Alternatively, an image reading device which is separate from the image forming apparatus 100 may be used to read the correction image P transferred to the sheet S, and based on image data of the correction image P obtained by the reading, the density of the correction image P may be detected. When the image reading device which is separate from the image forming apparatus 100 is used, after the detection of the density of the correction image P, by inputting the density data of the correction image P to the image forming apparatus 100, the control unit 4 can be caused to detect the density of the correction image P.

The correction image P is an image for detecting a beam spot interval between two light-emitting elements LD in which a scanning line on the surface to be scanned 10 is adjacent to the sub-scanning direction D2. In other words, the correction image P includes: an image P1 for detecting a beam spot interval between the light-emitting element LD4 and the light-emitting element LD1; an image P2 for detecting a beam spot interval between the light-emitting element LD1 and the light-emitting element LD2; an image P3 for detecting a beam spot interval between the light-emitting element LD2 and the light-emitting element LD3; and an image P4 for detecting a beam spot interval between the light-emitting element LD3 and the light-emitting element LD4. In the correction processing, the images P1, P2, P3 and P4 are formed in this order.

The correction image P includes a plurality of correction pattern images PT. The correction pattern images PT are arranged in the main scanning direction D1 and the sub-scanning direction D2. Six correction pattern images PT form a set image. For example, a plurality of images each of which is formed with six correction pattern images PT are arranged in the main scanning direction D1. Among the plurality of images arranged in the main scanning direction D1, at least one image is used, and thus the correction processing is performed.

Here, a detailed description will be given using, as an example, the image P2 for detecting the beam spot interval between the light-emitting element LD1 and the light-emitting element LD2. In the following description, when it is necessary to distinguish between six correction pattern images PT forming one set image, serial numbers 1 to 6 are added to the ends of the reference numerals of the six correction pattern images PT.

The correction pattern image PT1 and PT2 are adjacent to each other in the main scanning direction D1. The correction pattern image PT3 and PT4 are adjacent to each other in the main scanning direction D1. The correction pattern image PT5 and PT6 are adjacent to each other in the main scanning direction D1. The correction pattern images PT1, PT3 and PT5 are arranged in this order in the sub-scanning direction D2. The correction pattern images PT2, PT4 and PT6 are arranged in this order in the sub-scanning direction D2.

Each of the six correction pattern images PT includes a plurality of (six) patch images PC. Each of the patch images PC includes a first small image G1 and a second small image G2 each of which has a length corresponding to three pixels in the main scanning direction D1. The first small image G1 is obtained by developing an electrostatic latent image which is formed by scanning and exposure performed by the light-emitting element LD1. The second small image G2 is obtained by developing an electrostatic latent image which is formed by scanning and exposure performed by the light-emitting element LD2.

The correction pattern images PT3 and PT4 are symmetric with respect to a line. The correction pattern image PT1 differs from the correction pattern image PT3 in that the second small image G2 is displaced by one pixel to the negative direction side (left side) in the main scanning direction D1. The correction pattern image PT2 differs from the correction pattern image PT4 in that the second small image G2 is displaced by one pixel to the negative direction side (left side) in the main scanning direction D1. The correction pattern image PT5 differs from the correction pattern image PT3 in that the second small image G2 is displaced by one pixel to the positive direction side (right side) in the main scanning direction D1. The correction pattern image PT6 differs from the correction pattern image PT4 in that the second small image G2 is displaced by one pixel to the positive direction side (right side) in the main scanning direction D1.

After the formation of the correction image P, the control unit 4 detects the density of the correction image P based on the output of the density sensor 5. In the following description, the densities of the correction pattern images PT1, PT2, PT3, PT4, PT5 and PT6 are represented by Dn1, Dn2, Dn3, Dn4, Dn5 and Dn6, respectively. A differential density obtained by subtracting the density Dn1 from the density Dn2 is referred to as the “upper differential density (Dupper)”. A differential density obtained by subtracting the density Dn3 from the density Dn4 is referred to as the “middle differential density (Dmid)”. A differential density obtained by subtracting the density Dn5 from the density Dn6 is referred to as the “lower differential density (Dlower)”.

When no displacement of the writing start positions occurs between the light-emitting element LD1 and the light-emitting element LD2 in the main scanning direction D1 relative to the surface to be scanned 10 (in the ideal case), the correction image P as shown in FIG. 7 is formed.

In this case, as compared with the patch image PC of the correction pattern image PT2, the patch image PC of the correction pattern image PT1 is small in the main scanning direction D1, and the first small image G1 and the second small image G2 are densely packed, with the result that the density of the patch image PC is increased. In other words, the density of the correction pattern image PT1 is higher than that of the correction pattern image PT2.

The density of the patch image PC of the correction pattern image PT3 is substantially the same as that of the patch image PC of the correction pattern image PT4. In other words, the density of the correction pattern image PT3 is substantially the same as that of the correction pattern image PT4.

As compared with the patch image PC of the correction pattern image PT6, the patch image PC of the correction pattern image PT5 is large in the main scanning direction D1, and the first small image G1 and the second small image G2 are scattered, with the result that the density of the patch image PC is decreased. In other words, the density of the correction pattern image PT5 is lower than that of the correction pattern image PT6.

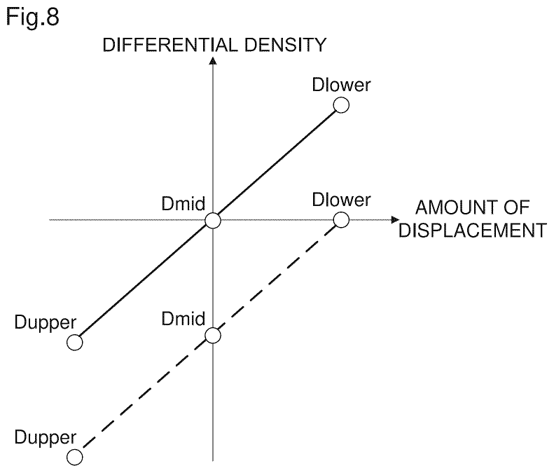

Consequently, a relationship between the amount of displacement (X axis) and the differential density (Y axis) is as shown in FIG. 8 (solid line). When the three points of the upper differential density (Dupper), the middle differential density (Dmid) and the lower differential density (Dlower) are plotted and connected by a straight line (hereinafter referred to as the density straight line), the intersection of the density straight line and the X axis is approximately zero. In other words, when the intersection of the density straight line and the X axis is approximately zero, it is said that no displacement of the writing start positions occurs between the light-emitting element LD1 and the light-emitting element LD2 in the main scanning direction D1 relative to the surface to be scanned 10.

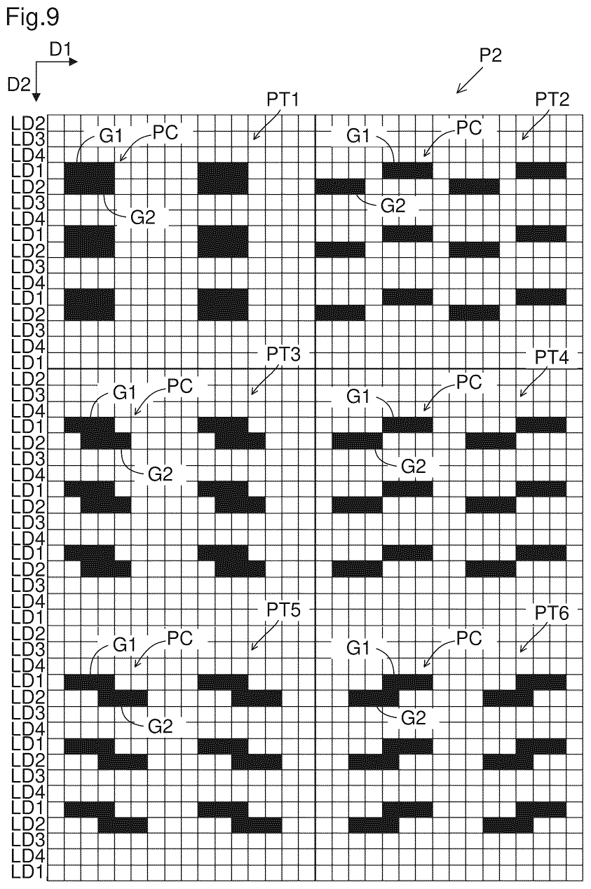

On the other hand, when a displacement of the writing start positions occurs between the light-emitting element LD1 and the light-emitting element LD2 in the main scanning direction D1 relative to the surface to be scanned 10, for example, the correction image P as shown in FIG. 9 is formed. Here, it is assumed that the writing start position of the light-emitting element LD2 in the main scanning direction D1 relative to the surface to be scanned 10 is displaced by one pixel to the negative direction side (left side) in the main scanning direction D1.

When a displacement of the writing start positions occurs (see FIG. 9), as compared with a case where no displacement of the writing start positions occurs (see FIG. 5), the density Dn1 of the correction pattern image PT1 is high, and the density Dn2 of the correction pattern image PT2 is low. The density Dn3 of the correction pattern image PT3 is high, and the density Dn4 of the correction pattern image PT4 is low. The density Dn5 of the correction pattern image PT5 is high, and the density Dn6 of the correction pattern image PT6 is low. Hence, the upper differential density (=Dn2−Dn1) is low, and the middle differential density (=Dn4−Dn3) is low and the lower differential density (=Dn6−Dn5) is low.

Consequently, a relationship between the amount of displacement (X axis) and the differential density (Y axis) is as shown in FIG. 8 (dashed line). When no displacement of the writing start positions occurs, the intersection of the density straight line (solid line) and the X axis is approximately zero whereas when a displacement of the writing start positions occurs, the intersection of the density straight line (dashed line) and the X axis is displaced from zero by about one pixel to the positive side. Therefore, a value obtained by inverting the sign of the X coordinate value of the intersection of the density straight line and the X axis corresponds to the amount of displacement of the writing start positions.

The method for calculating the amount of displacement of the writing start positions described here (method for detecting the beam spot intervals) is an example. Another method may be used to determine the amount of displacement of the writing start positions.

The control unit 4 determines the beam spot interval between the light-emitting element LD4 and the light-emitting element LD1, the beam spot interval between the light-emitting element LD1 and the light-emitting element LD2, the beam spot interval between the light-emitting element LD2 and the light-emitting element LD3 and the beam spot interval between the light-emitting element LD3 and the light-emitting element LD4. Then, the control unit 4 adjusts, based on the beam spot intervals, the timings of light emission of the light-emitting elements LD such that the writing start positions of the light-emitting elements LD in the main scanning direction D1 relative to the surface to be scanned 10 are aligned.

### First Processing

In the development processing in which the toner is supplied to the electrostatic latent image on the surface to be scanned 10, the thickness of the layer of the toner on the development roller 130 is restricted by blades. In this configuration, a foreign substance may be caught in the blades. If a foreign substance is caught in the blades, an abnormality occurs in the supply of the toner, and thus an insufficient amount of toner is supplied to a part of the surface to be scanned 10. In other words, unevenness in image density occurs, and thus the image quality is lowered.

For example, it is assumed that an abnormality occurs in the supply of the toner in positions indicated by white arrows in FIG. 7 and an area in the vicinity thereof. When in this state, the correction image P shown in FIG. 7 is formed, regardless of the beam spot intervals, the densities of the correction pattern images PT1, PT3 and PT5 are lower than expected.

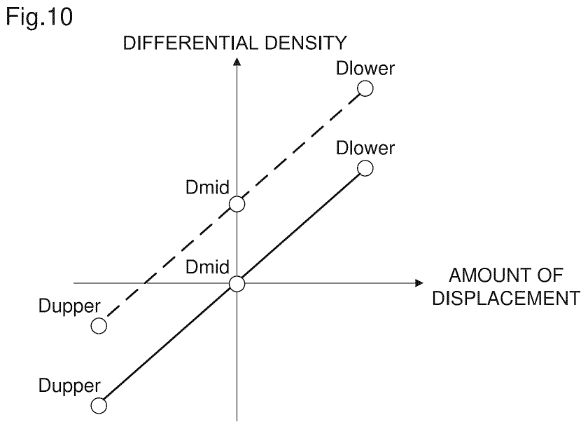

It is assumed that in this example, no displacement of the writing start positions of the light-emitting elements LD in the main scanning direction D1 relative to the surface to be scanned 10 occurs. In this case, each of the upper differential density (Dupper), the middle differential density (Dmid) and the lower differential density (Dlower) is higher than the differential density when the supply of the toner is normal. Consequently, as shown in FIG. 10, when the supply of the toner is normal, the intersection of the density straight line (solid line) and the X axis is approximately zero whereas when an abnormality occurs in the supply of the toner, the intersection of the density straight line (dashed line) and the X axis is displaced to the negative direction side.

When the correction processing is performed based on the amount of displacement described above, the timings of light emission of the light-emitting elements LD are unnecessarily adjusted. Consequently, the image quality is disadvantageously lowered as compared with the image quality before the correction processing is performed.

Hence, when the correction processing is performed, the control unit 4 performs first processing. The first processing is processing for determining whether unevenness in image density occurs on the surface to be scanned 10 in the main scanning direction D1. In this way, when the timings of light emission of the light-emitting elements LD are adjusted based on the density of the correction image P, that is, when the correction processing is performed, it is possible to determine whether the image density is lower than expected.

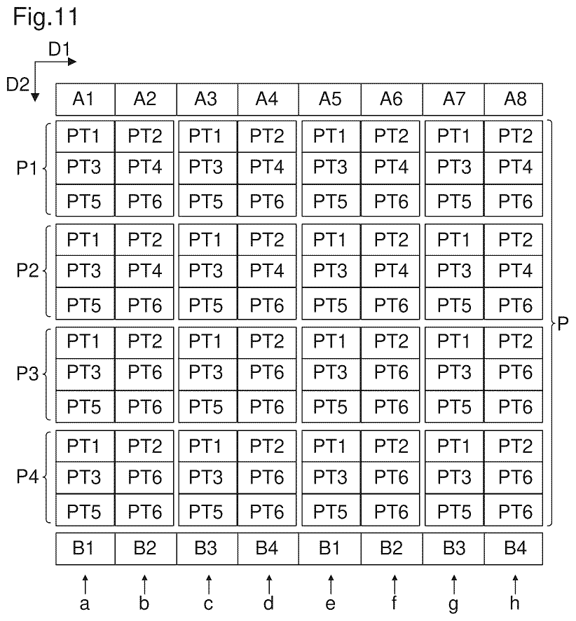

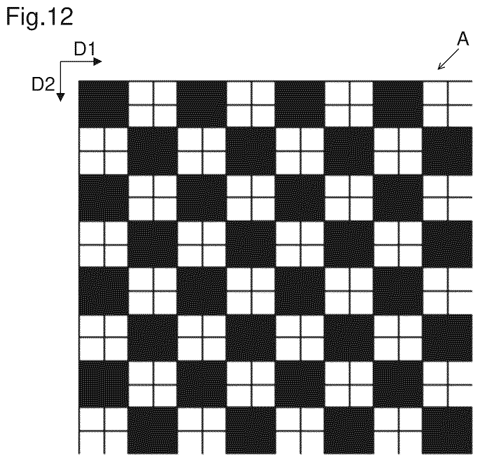

When the correction processing including the first processing is performed, as shown in FIGS. 11 and 12, the control unit 4 causes the image formation unit 1 (including the development device 13) and the optical scanning device 2 to form the first image A in addition to the correction image P. The first image A is a toner image which is used in the first processing. For example, the image formation unit 1 corresponding to black is used in the formation of the first image A. The optical scanning device 2 forms the electrostatic latent image of the first image A on the surface to be scanned 10. The development device 13 develops the electrostatic latent image on the surface to be scanned 10 into the toner image to form the first image A.

In the first processing, the density of the first image A is detected. Then, based on the density of the first image A, the first processing is performed. Hence, the first image A is transferred onto the outer circumferential surface of the intermediate transfer belt 3. Thereafter, for example, with the density sensor 5, the density of the first image A is detected. However, although not shown in the figure, a density sensor which can detect the density of the toner image on the surface to be scanned 10 may be installed to detect the density of the first image A on the surface to be scanned 10.

The same method as the method for detecting the density of the correction image P may be used to detect the density of the first image A. For example, a configuration may be adopted in which the first image A is transferred to the sheet S and output to the outside of the image forming apparatus, the first image A transferred to the sheet S is read with an image reading device and based on the image data of the first image A obtained by the reading, the density of the first image A is detected. The method for detecting the density of the first image A is the same as the method for detecting the density of the correction image P. Hence, the detailed description of the method for detecting the density of the first image A is omitted because the description of the method for detecting the density of the correction image P can be used.

Here, a plurality of first images A are formed. The first images A are arranged in the main scanning direction D1. The number of first images A formed is the same as the number of correction pattern images PT arranged in the main scanning direction D1. In the following description, when it is necessary to distinguish between the first images A, serial numbers 1 to 8 are added to the ends of the reference numerals of the first images A.

The position of each of the correction pattern images PT coincides with the position of any one of the first images A in the main scanning direction D1. In an example shown in FIG. 11, the positions of the correction pattern images PT in a column a coincide with the position of a first image A1 in the main scanning direction D1. The positions of the correction pattern images PT in a column b coincide with the position of a first image A2 in the main scanning direction D1. The positions of the correction pattern images PT in a column c coincide with the position of a first image A3 in the main scanning direction D1. The positions of the correction pattern images PT in a column d coincide with the position of a first image A4 in the main scanning direction D1. The positions of the correction pattern images PT in a column e coincide with the position of a first image A5 in the main scanning direction D1. The positions of the correction pattern images PT in a column f coincide with the position of a first image A6 in the main scanning direction D1. The positions of the correction pattern images PT in a column g coincide with the position of a first image A7 in the main scanning direction D1. The positions of the correction pattern images PT in a column h coincide with the position of a first image A8 in the main scanning direction D1.

The first images A are the same as each other. In other words, ideally, the densities of the first images A are the same as each other. The details of the first image A are not particularly limited as long as the area ratio of print dots is not 100% (that is, as long as the first image is not a solid image).

The control unit 4 detects the densities of the first images A based on the output of the density sensor 5. The control unit 4 determines a density difference (an absolute value thereof) between two first images A adjacent in the main scanning direction D1, and determines whether the determined density difference exceeds a predetermined first threshold value. Then, the control unit 4 determines that unevenness in image density occurs in the main scanning direction D1 when the density difference between the two first images A adjacent in the main scanning direction D1 exceeds the first threshold value. In other words, the control unit 4 determines that unevenness in image density occurs when one of the densities of the two first images A adjacent in the main scanning direction D1 is lowered due to an abnormality in the supply of the toner.

In the example shown in FIG. 11, a density difference between the first image A1 and the first image A2, a density difference between the first image A3 and the first image A4, a density difference between the first image A5 and the first image A6 and a density difference between the first image A7 and the first image A8 are determined, and each of the density differences is compared with the first threshold value. Then, when one of the density differences exceeds the first threshold value, it is determined that unevenness in image density occurs.

In a state where unevenness in image density occurs in the main scanning direction D1, the amount of displacement of the writing start positions in the main scanning direction D1 (that is, the beam spot intervals) cannot be accurately determined. Hence, when the correction processing is performed in the state where unevenness in image density occurs in the main scanning direction D1, the image quality can be disadvantageously lowered as compared with the image quality before the correction processing is performed.

Hence, when the control unit 4 determines that as a result of the first processing, unevenness in image density occurs in the main scanning direction D1, the control unit 4 stops the correction processing. In this way, it is possible to suppress a decrease in the image quality caused by unnecessarily adjusting the timings of light emission of the light-emitting elements LD.

However, the present disclosure is not limited to this configuration. A configuration may be adopted in which the correction processing is continued depending on the range of the occurrence of unevenness in image density.

Specifically, when the control unit 4 determines that as a result of the first processing, unevenness in image density occurs in the main scanning direction D1, the control unit 4 recognizes, as density unevenness occurrence positions, the positions of the two first images A in the main scanning direction D1 in which the density difference between the two first images exceeds the first threshold value. Then, the control unit 4 does not use, in the correction processing, the correction pattern images PT in which the positions of the correction pattern images PT in the main scanning direction D1 are the density unevenness occurrence positions, and performs the correction processing based on the densities of the correction pattern images PT in which the positions of the correction pattern images in the main scanning direction D1 are not the density unevenness occurrence positions.

For example, in the example shown in FIG. 11, the density difference between the first image A1 and the first image A2 is assumed to exceed the first threshold value. In this case, the positions of the first image A1 and the first image A2 in the main scanning direction D1 are recognized as the density unevenness occurrence positions. Hence, the correction pattern images PT in the columns a and b are not used in the correction processing, and based on the densities of the correction pattern images PT in the columns c to h, the correction processing is performed.

In this configuration, even when the correction processing is performed in the state where unevenness in image density occurs, it is possible to suppress a decrease in the image quality as compared with the image quality before the correction processing is performed. In this configuration, the correction processing is performed, and thus it is possible to suppress a decrease in the image quality caused by a displacement of the writing start positions in the main scanning direction D1.

### Second Processing

The amount of light emitted by the light-emitting element LD in which an abnormality occurs is lowered beyond the initial value. In other words, the amount of light emitted by the light-emitting element LD in which an abnormality occurs is lowered beyond the amounts of light emitted by the other light-emitting elements LD. Hence, when a light amount abnormality (that is, a decrease in the amount of light) occurs in any one of the light-emitting elements LD, the image quality is lower than expected.

For example, a light amount abnormality is assumed to occur in the light-emitting element LD1. When in this state, the correction image P as shown in FIG. 7 is formed, the density of the first small image G1 is lowered. In other words, the densities of all the correction pattern images PT1 to PT6 are lowered.

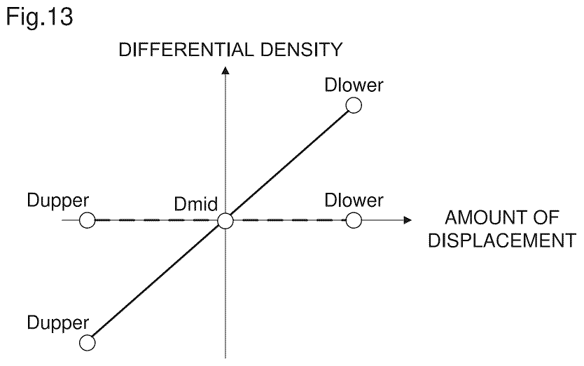

In this example, it is assumed that almost no toner is applied to the position of the first small image G1. In this case, the densities of the correction pattern images PT1 to PT6 are substantially the same as each other. Consequently, as shown in FIG. 13, when all the light-emitting elements LD are normal, a density straight line as indicated by a solid line is obtained whereas when an abnormality occurs in the light-emitting element LD1, all the upper differential density (Dupper), the middle differential density (Dmid) and the lower differential density (Dlower) are approximately zero.

Consequently, it is impossible to determine the amount of displacement of the writing start positions in the main scanning direction D1. In other words, it is impossible to accurately perform the correction processing.

Hence, when the correction processing is performed, the control unit 4 performs second processing. The second processing is processing for determining whether a light amount abnormality occurs in any one of the light-emitting elements LD. In this way, when the timings of light emission of the light-emitting elements LD are adjusted based on the density of the correction image P, that is, when the correction processing is performed, it is possible to determine whether the image density is lower than expected.

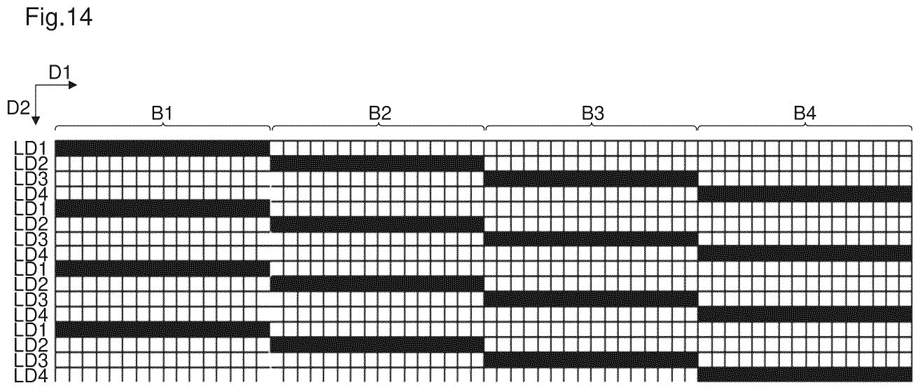

When the correction processing including the second processing is performed, as shown in FIGS. 11 and 14, the control unit 4 causes the image formation unit 1 (including the development device 13) and the optical scanning device 2 to form a second image B in addition to the correction image P. The second image B is a toner image which is used in the second processing. For example, the image formation unit 1 corresponding to black is used in the formation of the second image B. The optical scanning device 2 forms the electrostatic latent image of the second image B on the surface to be scanned 10. The development device 13 develops the electrostatic latent image on the surface to be scanned 10 into the toner image to form the second image B.

In the second processing, the density of the second image B is detected. Then, based on the density of the second image B, the second processing is performed. Hence, the second image B is transferred onto the outer circumferential surface of the intermediate transfer belt 3. Thereafter, for example, with the density sensor 5, the density of the second image B is detected. However, although not shown in the figure, a density sensor which can detect the density of the toner image on the surface to be scanned 10 may be installed to detect the density of the second image B on the surface to be scanned 10.

The same method as the method for detecting the density of the correction image P may be used to detect the density of the second image B. For example, a configuration may be adopted in which the second image B is transferred to the sheet S and output to the outside of the image forming apparatus, the second image B transferred to the sheet S is read with an image reading device and based on the image data of the second image B obtained by the reading, the density of the second image B is detected. The method for detecting the density of the second image B is the same as the method for detecting the density of the correction image P. Hence, the detailed description of the method for detecting the density of the second image B is omitted because the description of the method for detecting the density of the correction image P can be used.

Here, a plurality of second images B are formed. The second images B correspond to different light-emitting elements LD, respectively. In other words, the number of types of second images B are four. In the following description, when it is necessary to distinguish between the second images B, number 1 is added to the end of the reference numeral of the second image B corresponding to the light-emitting element LD1, number 2 is added to the end of the reference numeral of the second image B corresponding to the light-emitting element LD2, number 3 is added to the end of the reference numeral of the second image B corresponding to the light-emitting element LD3 and number 4 is added to the end of the reference numeral of the second image B corresponding to the light-emitting element LD4.

Each of the second images B is obtained by developing an electrostatic latent image formed only by scanning using a light beam emitted from the corresponding light-emitting element LD. For example, the light-emitting elements LD1, LD2, LD3 and LD4 are turned on and off in this order, and thus the electrostatic latent images of the second images B1, B2, B3 and B4 are formed. The number of second images B which correspond to the light-emitting elements LD and which are formed may be one or two or more. FIG. 11 shows, as an example, a case where the number of second images B which correspond to the light-emitting elements LD and which are formed is two.

The control unit 4 detects the densities of the second images B based on the output of the density sensor 5. The control unit 4 determines the average value (hereinafter referred to as the “average density value”) of the densities of the second images B. The control unit 4 further determines, for each of the second images B, whether a difference (an absolute value thereof) between the density of the second image B and the average density value exceeds a predetermined second threshold value. The control unit 4 determines that a light amount abnormality occurs in the light-emitting element LD corresponding to the second image B in which the difference between the density of the second image B and the average density value exceeds the second threshold value.

For example, when a light amount abnormality occurs in the light-emitting element LD1, the density of the second image B1 is lowered. Hence, the difference between the density of the second image B1 and the average density value exceeds the second threshold value. Consequently, it is determined that a light amount abnormality occurs in the light-emitting element LD1.

In a state where a light amount abnormality occurs in any one of the light-emitting elements LD, the amount of displacement of the writing start positions in the main scanning direction D1 (that is, the beam spot intervals) cannot be accurately determined. Hence, when the correction processing is performed in the state where a light amount abnormality occurs in any one of the light-emitting elements LD, the image quality can be disadvantageously lowered as compared with the image quality before the correction processing is performed.

Hence, when the control unit 4 determines that as a result of the second processing, a light amount abnormality occurs in any one of the light-emitting elements LD (the second image B in which the difference between the density of the second image B and the average density value exceeds the second threshold value is present), the control unit 4 stops the correction processing. In this way, it is possible to suppress a decrease in the image quality caused by unnecessarily adjusting the timings of light emission of the light-emitting elements LD.

However, the present disclosure is not limited to this configuration. A configuration may be adopted in which the correction processing is continued even when a light amount abnormality occurs in any one of the light-emitting elements LD.

Specifically, when the control unit 4 determines that as a result of the second processing, a light amount abnormality occurs in any one of the light-emitting elements LD, the control unit 4 performs light amount adjustment processing for adjusting the amount of light emitted by the light-emitting element LD in which the light amount abnormality occurs. In the following description, the light-emitting element LD (that is, the light-emitting element LD in which a light amount abnormality occurs) which is the target of the light amount adjustment processing is referred to as the target light-emitting element LD.

The control unit 4 performs the light amount adjustment processing to increase the density of the second image B corresponding to the target light-emitting element LD beyond the density before the light amount adjustment processing is performed. In other words, the control unit 4 performs the light amount adjustment processing to increase the amount of light emitted by the target light-emitting element LD. In this way, the control unit 4 sets the density of the second image B corresponding to the target light-emitting element LD to the same as the average density value. Then, the control unit 4 performs the light amount adjustment processing, then causes the image formation unit 1 (including the development device 13) and the optical scanning device 2 to form the correction image P again and performs the correction processing.

In this configuration, even when a light amount abnormality occurs in any one of the light-emitting elements LD, since the light amount adjustment processing is performed on the light-emitting element LD described above, it is possible to determine the amount of displacement of the writing start positions in the main scanning direction D1. In other words, even when a light amount abnormality occurs in any one of the light-emitting elements LD, the correction processing can be performed if necessary.

However, in some cases, the amount of light emitted by the target light-emitting element LD is decreased to such an extent that the light amount adjustment processing cannot cope with the decrease. In this case, the correction processing is preferably stopped. Hence, as the second processing, the following processing may be additionally performed. As the second processing, only the following processing may be performed.

Specifically, the control unit 4 determines, for each of the second images B, whether the density of the second image B falls below a predetermined lower limit density value. The control unit 4 determines that a light amount abnormality occurs in the light-emitting element LD corresponding to the second image B in which its density falls below the lower limit density value.

Then, when the control unit 4 determines that a light amount abnormality occurs in any one of the light-emitting elements LD (the second image B in which its density falls below the lower limit density value is present), the control unit 4 stops the correction processing. In this way, it is possible to suppress a decrease in the image quality caused by unnecessarily adjusting the timings of light emission of the light-emitting elements LD.

The embodiment disclosed herein should be considered to be illustrative in all respects and not restrictive. The scope of the present disclosure is indicated not by the description of the above embodiment but by the scope of claims, and furthermore, meanings equivalent to the scope of claims and all changes in the scope are included therein.

What is claimed is:

1. An image forming apparatus comprising:
an image carrying member that includes a surface to be scanned;
an optical scanning device that
includes a plurality of light-emitting elements arranged in a line at regular intervals and at a predetermined angle relative to a main scanning direction, and
scans the surface to be scanned with light beams emitted from the plurality of light-emitting elements to form an electrostatic latent image on the surface to be scanned;
a development device that develops the electrostatic latent image using a toner to form a toner image; and
a control unit that performs correction processing to correct a displacement of writing start positions of the plurality of light-emitting elements in the main scanning direction relative to the surface to be scanned,
wherein the control unit performs the correction processing by
causing the optical scanning device and the development device to form a correction image that is the toner image used in the correction processing,
determining the displacement of the writing start positions based on a density of the correction image and
adjusting timings of light emission of the plurality of light-emitting elements based on the displacement of the writing start positions determined to correct the displacement of the writing start positions,
when the control unit performs the correction processing, the control unit performs at least one of first processing and second processing,
the control unit performs the first processing by
causing the optical scanning device and the development device to form a first image that is the toner image used in the first processing, and
determining, based on a density of the first image, whether unevenness in image density occurs on the surface to be scanned and
the control unit performs the second processing by
causing the optical scanning device and the development device to form a second image that is the toner image used in the second processing, and
determining, based on a density of the second image, whether a light amount abnormality occurs in any one of the plurality of light-emitting elements.

2. The image forming apparatus according to claim 1,
wherein a plurality of first images each being the first image are formed,
the plurality of first images are arranged in the main scanning direction,
the correction image includes a plurality of correction pattern images,
a position of each of the plurality of correction pattern images coincides with a position of any one of the plurality of first images in the main scanning direction,
the control unit performs the first processing by
determining that the unevenness in image density occurs when a density difference between two first images each of which is the first image and which are adjacent in the main scanning direction exceeds a predetermined first threshold value and
when the control unit determines that the unevenness in image density occurs, the control unit stops the correction processing.

3. The image forming apparatus according to claim 1,
wherein a plurality of first images each being the first image are formed,
the plurality of first images are arranged in the main scanning direction,
the correction image includes a plurality of correction pattern images,
a position of each of the plurality of correction pattern images coincides with a position of any one of the plurality of first images in the main scanning direction,
the control unit performs the first processing by
determining that the unevenness in image density occurs when a density difference between two first images each of which is the first image and which are adjacent in the main scanning direction exceeds a predetermined first threshold value and
when the control unit determines that the unevenness in image density occurs, the control unit
recognizes, as density unevenness occurrence positions, positions of the two first images in the main scanning direction, the density difference between the two first images exceeding the first threshold value,
does not use, in the correction processing, the correction pattern images in which positions of the correction pattern images in the main scanning direction are the density unevenness occurrence positions and
performs the correction processing based on densities of the correction pattern images in which positions of the correction pattern images in the main scanning direction are not the density unevenness occurrence positions.

4. The image forming apparatus according to claim 1,
wherein a plurality of second images each being the second image are formed,
the plurality of second images respectively correspond to the plurality of light-emitting elements,
each of the plurality of second images is obtained by developing the electrostatic latent image formed only by scanning using a light beam emitted from the corresponding light-emitting element,
the control unit performs the second processing by
determining an average density value of the plurality of second images,
determining, for each of the plurality of second images, whether a difference between the density of the second image and the average density value exceeds a predetermined second threshold value and
determines that the light amount abnormality occurs in the light-emitting element corresponding to the second image in which the difference between the density of the second image and the average density value exceeds the second threshold value and
when the control unit determines that the light-emitting element in which the light amount abnormality occurs is present, the control unit stops the correction processing.

5. The image forming apparatus according to claim 1,
wherein a plurality of second images each being the second image are formed,
the plurality of second images respectively correspond to the plurality of light-emitting elements,
each of the plurality of second images is obtained by developing the electrostatic latent image formed only by scanning using a light beam emitted from the corresponding light-emitting element,
the control unit performs the second processing by
determining, for each of the plurality of second images, whether the density of the second image falls below a predetermined lower limit density value, and
determines that the light amount abnormality occurs in the light-emitting element corresponding to the second image in which the density of the second image falls below the lower limit density value and
when the control unit determines that the light-emitting element in which the light amount abnormality occurs is present, the control unit stops the correction processing.

6. The image forming apparatus according to claim 1,
wherein a plurality of second images each being the second image are formed,
the plurality of second images respectively correspond to the plurality of light-emitting elements,
each of the plurality of second images is obtained by developing the electrostatic latent image formed only by scanning using a light beam emitted from the corresponding light-emitting element,
the control unit performs the second processing by
determining an average density value of the plurality of second images,
determining, for each of the plurality of second images, whether a difference between the density of the second image and the average density value exceeds a predetermined second threshold value and
determines that the light amount abnormality occurs in the light-emitting element corresponding to the second image in which the difference between the density of the second image and the average density value exceeds the second threshold value and
when the control unit determines that the light-emitting element in which the light amount abnormality occurs is present, the control unit performs the correction processing by
adjusting an amount of light emitted by the light-emitting element in which the light amount abnormality occurs, and
then causing the optical scanning device and the development device to from the correction image.

7. The image forming apparatus according to claim 1, further comprising:
a transfer unit that transfers the toner image to a sheet,
wherein the density of the correction image is detected based on image data obtained by reading the correction image transferred to the sheet,
the density of the first image is detected based on image data obtained by reading the first image transferred to the sheet and
the density of the second image is detected based on image data obtained by reading the second image transferred to the sheet.
